(19) United States
(12) Patent Application Publication
(10) Pub. No.: US 2026/0213658 A1
(43) Pub. Date: Jul. 23, 2026

(54) POWER SUPPLY CIRCUIT, CONTROL METHOD, AND ELECTRONIC APPARATUS

(71) Applicant: SONY GROUP CORPORATION, TOKYO (JP)

(72) Inventors: TOSHIAKI IDEI, TOKYO (JP); KENJI KAWASAKI, TOKYO (JP); HIROTAKA NONAKA, TOKYO (JP); MITSUHARU KURIHARA, TOKYO (JP)

(21) Appl. No.: 19/141,162

(22) PCT Filed: Nov. 28, 2023
(86) PCT No.: PCT/JP2023/042446

§ 371 Date: Jun. 19, 2025

(30) Foreign Application Priority Data
Dec. 27, 2022 (JP) 2022-210642

(51) Int. Cl. H02M 3/158; H02J 7/34; H02M 1/00

(52) U.S. Cl. CPC H02M 3/158; H02J 7/34; H02M 1/0067; H02M 1/0025

(57) ABSTRACT

For example, a power supply circuit with an improved conversion efficiency is provided. Provided is a power supply circuit including: a voltage conversion circuit that converts an input voltage; a first power storage element that smooths an output of the voltage conversion circuit; a bidirectional voltage conversion circuit that is connected in parallel, on an output side thereof, to the first power storage element; and a second power storage element that is connected to an input side of the bidirectional voltage conversion, in which the voltage conversion circuit controls a voltage of the second power storage element to have a second voltage value, and the bidirectional voltage conversion circuit controls a voltage of the first power storage element to have a first voltage value.

### TECHNICAL FIELD

The present disclosure relates to a power supply circuit, a control method, and an electronic apparatus.

### BACKGROUND ART

Power supply circuits described in, for example, Patent Literatures 1 and 2 are known as power supply circuits connected to loads.

### CITATION LIST

### Patent Literature

Patent Literature 1: Japanese Patent Application Laid-open No. 2022-11203
Patent Literature 2: Japanese Patent Application Laid-open No. 2014-90622

### DISCLOSURE OF INVENTION

### Technical Problem

In such fields, it is desired to improve a conversion efficiency of a power supply circuit in order to reduce the power consumption of an electronic apparatus from the viewpoint of environmental friendliness.

It is an object of the present disclosure to provide a power supply circuit with an improved conversion efficiency, a control method for the power supply circuit, and an electronic apparatus using the power supply circuit.

### Solution to Problem

The present disclosure is, for example, a power supply circuit including:
a voltage conversion circuit that converts an input voltage;
a first power storage element that smooths an output of the voltage conversion circuit;
a bidirectional voltage conversion circuit that is connected in parallel, on an output side thereof, to the first power storage element; and
a second power storage element that is connected to an input side of the bidirectional voltage conversion, in which
the voltage conversion circuit controls a voltage of the second power storage element to have a second voltage value, and
the bidirectional voltage conversion circuit controls a voltage of the first power storage element to have a first voltage value.

The present disclosure may be an electronic apparatus including the power supply circuit described above.

The present disclosure is, for example, a control method including:
converting an input voltage by a voltage conversion circuit;
smoothing an output of the voltage conversion circuit by a first power storage element;
controlling a voltage of the first power storage element to have a first voltage value by a bidirectional voltage conversion circuit that is connected in parallel, on an output side thereof, to the first power storage element and connected on an input side thereof to a second power storage element; and
controlling a voltage of the second power storage element to have a second voltage value by the voltage conversion circuit.

### BRIEF DESCRIPTION OF DRAWINGS

FIG. 1 is a diagram referred to when problems to be considered in the present disclosure are described.

FIG. 2 is a diagram for describing a configuration example of a power supply circuit according to a first embodiment.

FIG. 3 is a diagram referred to when an operation example of the power supply circuit according to the first embodiment is described.

FIG. 4 is a diagram referred to when an operation example of the power supply circuit according to the first embodiment is described.

FIG. 5 is a diagram referred to when an operation example of a power supply circuit according to a second embodiment is described.

FIG. 6 is a diagram for describing an example of the present disclosure.

FIG. 7 is a diagram for describing an example of the present disclosure.

FIG. 8 is a diagram for describing a modified example.

### MODE(S) FOR CARRYING OUT THE INVENTION

Embodiments and the like of the present disclosure will be described below with reference to the drawings. Note that description will be given in the following order.

### Problems To Be Considered in Present Disclosure

### First Embodiment

### Second Embodiment

### <Modified Example>

Note that embodiments and the like of the present disclosure to be described below are suitable specific examples of the present disclosure, and contents of the present disclosure are not limited to those embodiments and the like.

### <Problems To Be Considered in Present Disclosure>

First, the problems to be considered in the present disclosure will be described in order to facilitate understanding of the present disclosure. As described above, there is a demand for improvement in conversion efficiency in the fields of power supply circuits. In general, the efficiency of a power supply circuit is poor in the range of a load factor smaller than a maximum load, and there are many power supply circuits that exert the maximum conversion efficiency in the range of a midrange or larger load factor than the maximum load. In particular, such tendency becomes stronger in the power supply circuits that reduce a switching loss by using a resonance phenomenon.

However, among electronic apparatuses, there are many devices, such as motors, audio devices, and lighting devices, providing small actual average power with respect to instantaneous maximum power. The power supply circuits mounted on such electronic apparatuses are used for a long time with a small load with respect to the maximum load and are used in the state of a poor conversion efficiency. In order to solve such problems, the above-mentioned technology described in the Patent Literature 1 uses a power supply circuit that stores electric energy (hereinafter, also simply referred to as energy) when a load current is small, and discharges the energy when the load current increases, thereby time-shifting the peak power of the electronic apparatus.

In this method, since a decrease in voltage or an increase in load current are confirmed to operate a peak power suppression circuit, a supply voltage varies. An audio device or a lighting device (e.g., a backlight of a television apparatus) is a device having a repeated peak load and a small actual load, but in the case of such an electronic apparatus, the variations in the supply voltage cause flickering of a screen or sound quality, and thus the technology of Patent Literature 1 cannot be applied.

Further, the technology described in Patent Literature 2 has a configuration that may suppress variations in output voltage, but a peak shift circuit operates and thus causes a loss even in a suppliable range by an insulating power supply alone. Furthermore, the load factor of the insulating power supply is small constantly, and the efficiency is thus deteriorated, so that efficiency has been difficult to improve in the actual use region. In consideration of the above description, details of the present disclosure will be described using the embodiments.

### First Embodiment

### [Example of Load]

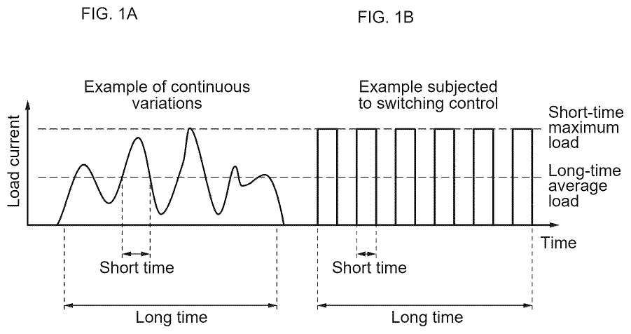

First, a specific example of an electronic apparatus (load) that can be connected to a power supply circuit of the present disclosure will be described. A and B of FIG. 1 each show an example of such an electronic apparatus. In A and B of FIG. 1, the horizontal axis represents time, and the vertical axis represents the magnitude of a load current. An electronic apparatus connected to the power supply circuit is assumed to be a load apparatus that generates an average load continuously obtained in a long time and a load apparatus that generates a larger peak load than a continuous load even in a short time. As will be described later in detail, the power supply circuit according to the present disclosure needs to be capable of continuously supplying power requested in an average load region, but it does not have to be capable of supplying power requested when the load is at its peak.

A load may be obtained in a continuous manner or may be obtained in a discrete manner by on/off control of a switch. Time settings for a short-time peak load/a long-time average load differ depending on the electronic apparatus serving as the load.

A of FIG. 1 shows variations in load current of an audio device that is a specific example of the former case. The load current of the audio device varies continuously as shown in A of FIG. 1. Assuming that a load of 20 Hz is the minimum frequency, in the case of the audio device, 50 ms or less is a short time, and 50 ms or more is a long time.

B of FIG. 1 shows variations in load current of a lighting device (specifically, backlight) of a television apparatus that is a specific example of the latter case. The load current of the lighting device of the television apparatus discretely varies by switching control as shown in B of FIG. 1. When pulse width modulation (PWM) control in the cycle of 60 Hz is assumed, 17 ms or less is a short time, and a value larger than 17 ms is a long time.

The power supply circuit according to the present disclosure can be applied to the above-mentioned audio device or television apparatus, a motor control circuit, and various other electronic apparatuses.

### [Configuration Example of Power Supply Circuit]

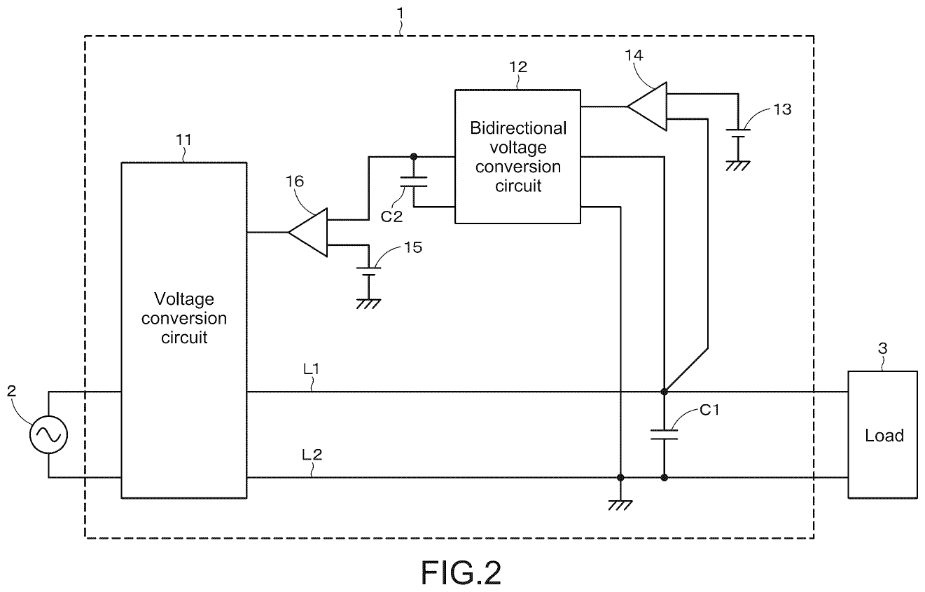

FIG. 2 is a diagram for describing a configuration example of the power supply circuit (power supply circuit 1) according to the first embodiment. In the power supply circuit 1, an input power supply 2 is connected to the input side, and a load 3 is connected to the output side. The input power supply 2 is, for example, a commercial power supply. The input power supply 2 may be a battery or the like. The load 3 may be the above-mentioned audio device or lighting device, but it may be another electronic apparatus.

The power supply circuit 1 includes, for example, a voltage conversion circuit 11, a bidirectional voltage conversion circuit 12, a first reference voltage supply 13, a first error amplifier 14, a second reference voltage supply 15, a second error amplifier 16, a first capacitor C1, and a second capacitor C2.

The voltage conversion circuit 11 appropriately converts the input voltage from the input power supply 2 and outputs the converted voltage via output lines L1 and L2. The output lines L1 and L2 are connected to the load 3. For example, an LLC resonant converter can be used as the voltage conversion circuit 11.

The first capacitor C1, which is an example of a first power storage element, smooths the output of the voltage conversion circuit 11. A power storage element such as an electrolytic capacitor or an electric double-layer capacitor can be used as the first capacitor C1.

The second capacitor C2 is an example of a second power storage element. A power storage element such as an electrolytic capacitor or an electric double-layer capacitor can be used as the second capacitor C2.

The bidirectional voltage conversion circuit 12 is a circuit capable of charging and discharging the second capacitor C2. The second capacitor C2 is connected to the input side of the bidirectional voltage conversion circuit 12. Further, the output side of the bidirectional voltage conversion circuit 12 is connected in parallel to the first capacitor C1.

The first reference voltage supply 13 generates a set voltage (hereinafter, also appropriately referred to as a first voltage value) for the first capacitor C1. The first voltage value in this embodiment is a fixed value set in advance. The first voltage value is input to one input terminal of the first error amplifier 14. As will be described later in detail, in the power supply circuit 1, the bidirectional voltage conversion circuit 12 operates to control the voltage of the first capacitor C1 to have (to maintain) the first voltage value.

The voltage value of the first capacitor C1 is input to the other input terminal of the first error amplifier 14. The first error amplifier 14 outputs a voltage obtained by amplifying a voltage difference between two inputs, i.e., the first voltage value and the voltage value of the first capacitor C1. A detection result of the first error amplifier 14 is input to the bidirectional voltage conversion circuit 12.

The second reference voltage supply 15 generates a set voltage (hereinafter, also appropriately referred to as a second voltage value) for the second capacitor C2. The second voltage value in this embodiment is a fixed value set in advance. Note that the first voltage value and the second voltage value may be the same value or may be different values. The second voltage value is input to one input terminal of the second error amplifier 16. As will be described later in detail, in the power supply circuit 1, the voltage conversion circuit 11 operates to control the voltage of the second capacitor C2 to have (to maintain) the second voltage value.

The voltage value of the second capacitor C2 is input to the other input terminal of the second error amplifier 16. The second error amplifier 16 outputs a voltage obtained by amplifying a voltage difference between two inputs, i.e., the second voltage value and the voltage value of the second capacitor C2. A detection result of the second error amplifier 16 is input to the voltage conversion circuit 11.

### [Operation Example of Power Supply Circuit]

### (First Operation Example)

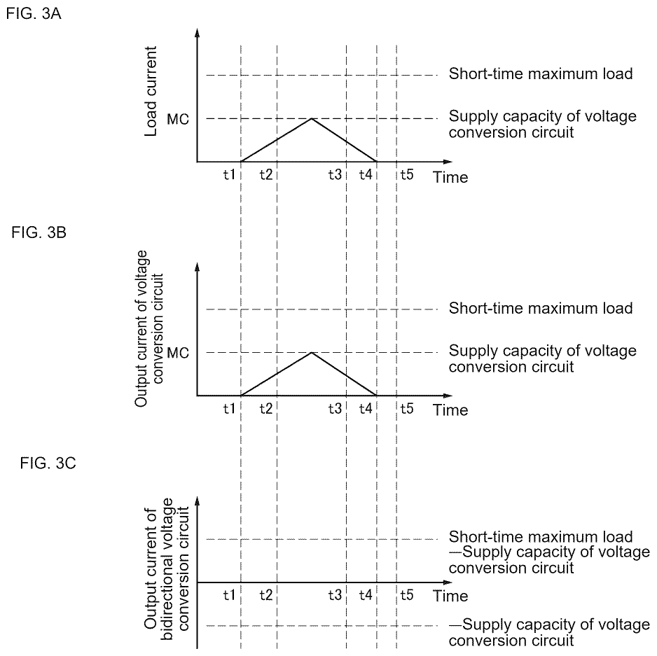

Next, operation examples of the power supply circuit 1 will be described. First, a first operation example of the power supply circuit 1 will be described with reference to FIG. 3. The first operation example is an operation example of the power supply circuit 1 when the load current required for the load 3 is equal to or smaller than a suppliable maximum current of the voltage conversion circuit 11.

A of FIG. 3 shows a temporal change of the magnitude of the load current. B of FIG. 3 shows a temporal change of the magnitude of an output current (supply current) of the voltage conversion circuit 11. C of FIG. 3 shows a temporal change of the magnitude of an output current of the bidirectional voltage conversion circuit 12.

As shown in A of FIG. 3, for example, when the load 3 is connected to the power supply circuit 1 at timing t1, the load current flows. In the example shown in A of FIG. 3, the load current increases along with the elapse of time (e.g., from timing t1 to timing t2), and reaches its maximum around the middle of timing t2 and timing t3. The load current then gradually decreases and reaches zero at timing t4. In this example, the increase and decrease in the load current are continuous, but as described above, the increase and decrease in the load current can be discrete depending on the load 3. In any case, in this example, the load current does not exceed a suppliable maximum current MC of the voltage conversion circuit 11. As shown in B of FIG. 3, the voltage conversion circuit 11 supplies a current corresponding to the increase and decrease in the load current to the load 3.

The load current flows, which causes the voltage of the first capacitor C1 to drop, and the first error amplifier 14 detects that the voltage of the first capacitor C1 has dropped to the first voltage value or lower. The detection result of the first error amplifier 14 is supplied to the bidirectional voltage conversion circuit 12. The bidirectional voltage conversion circuit 12 to which the detection result of the first error amplifier 14 has been supplied controls the voltage of the first capacitor C1 to have the first voltage value. Specifically, the bidirectional voltage conversion circuit 12 discharges the second capacitor C2 and supplies a discharge current caused by discharging the second capacitor C2 to the first capacitor C1. This controls the voltage of the first capacitor C1 to have the first voltage value.

The second capacitor C2 is discharged, and the voltage of the second capacitor C2 decreases. The second error amplifier 16 detects that the voltage of the second capacitor C2 has decreased to the second voltage value or lower. The voltage conversion circuit 11 to which the detection result of the second error amplifier 16 has been supplied controls the voltage of the second capacitor C2 to have the second voltage value. Specifically, the voltage conversion circuit 11 supplies the current to the second capacitor C2 in order to set the voltage of the second capacitor C2 to the second voltage value. This current is supplied to the second capacitor C2 via the first capacitor C1 and the bidirectional voltage conversion circuit 12. As a result, the supply capacity of the voltage conversion circuit 11 and the load current of the load 3 are matched, and the operation is continued in the state in which the supply current of the bidirectional voltage conversion circuit 12 is zero as shown in C of FIG. 3.

### (Second Operation Example)

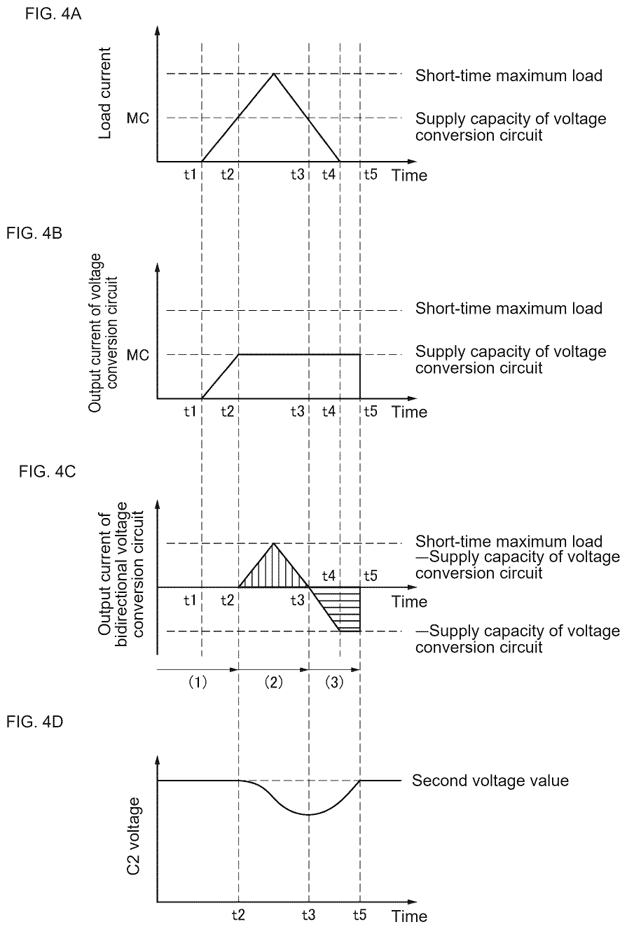

Next, a second operation example of the power supply circuit 1 will be described with reference to FIG. 4. The second operation example is an operation example of the power supply circuit 1 when the load current required for the load 3 is larger than the suppliable maximum current of the voltage conversion circuit 11.

A of FIG. 4 shows a temporal change of the magnitude of the load current. B of FIG. 4 shows a temporal change of the magnitude of the output current of the voltage conversion circuit 11. C of FIG. 4 shows a temporal change of the magnitude of the output current of the bidirectional voltage conversion circuit 12. D of FIG. 4 shows a temporal change of the voltage of the second capacitor C2.

As shown in A of FIG. 4, in this example, it is assumed that the load current of the load 3 becomes larger than the suppliable maximum current MC of the voltage conversion circuit 11 from timing t2 to timing t3.

After the load 3 is connected to the power supply circuit 1, in the interval in which the load current is equal to or lower than the suppliable maximum current MC of the voltage conversion circuit 11 (interval from timing t1 to timing t2), the voltage conversion circuit 11 outputs a current corresponding to the load current (see the interval from timing t1 to timing t2 in B of FIG. 4). At that time, as described above, the output current of the voltage conversion circuit 11 is balanced with the load current, and the current of the bidirectional voltage conversion circuit 12 becomes zero (see the interval from timing t1 to timing t2 in C of FIG. 4).

At timing t2, the load current exceeds the supply capacity of the voltage conversion circuit 11. The load current exceeding the supply capacity of the voltage conversion circuit 11 is supplied from the bidirectional voltage conversion circuit 12 by an operation to maintain the voltage of the first capacitor C1 by the bidirectional voltage conversion circuit 12. In other words, the bidirectional voltage conversion circuit 12 supplies a discharge current caused by discharging the second capacitor C2 to the first capacitor C1. The voltage of the second capacitor C2 gradually decreases because the voltage (energy) of the second capacitor C2 continues to shift to the first capacitor C1 by the operation of the bidirectional voltage conversion circuit 12 (see D of FIG. 4).

After timing t3 has passed, that is, even when the load current is equal to or lower than the supply capacity of the power supply, the voltage conversion circuit 11 does not decrease the output current according to the load current and continues to output the suppliable maximum current MC (see B of FIG. 4) because the voltage of the second capacitor C2 is lowered.

In the suppliable maximum current MC, the current exceeding the load current (excess current) is supplied from the voltage conversion circuit 11 to the first capacitor C1, but by the operation to maintain the voltage of the first capacitor C1 by the bidirectional voltage conversion circuit 12, the excess current is stored in the second capacitor C2 (the second capacitor C2 is charged with a negative current from the perspective of the bidirectional voltage conversion circuit 12). Thus, the voltage of the second capacitor C2 is restored (see D of FIG. 4). The voltage conversion circuit 11 outputs the suppliable maximum current MC until the voltage of the second capacitor C2 reaches the second voltage value even when the load current reaches zero at timing t4.

When the voltage of the second capacitor C2 is restored to the second voltage value (see timing t5 in D of FIG. 4), the voltage conversion circuit 11 stops the output. As in the state from timing t1 to timing t2, the load current and the output current of the voltage conversion circuit 11 are matched, and the current of the bidirectional voltage conversion circuit 12 is in the state of zero. Here, the discharge energy of the bidirectional voltage conversion circuit 12 in the state from timing t2 to timing t3 (portion with vertical hatching) and the charge energy of the bidirectional voltage conversion circuit 12 in the state from timing t3 to timing t5 (portion with horizontal hatching) have equal values.

### [Effects Obtained in This Embodiment]

According to this embodiment, the power supply circuit does not need to cope with a short-time peak load and operates at a constantly high load factor, so that the conversion efficiency of the power supply is improved. The improvement in efficiency makes it possible to achieve downsizing of the power supply circuit and reduction in costs. Further, this configuration constantly feeds the voltage, which is to be supplied to the load, back to the bidirectional voltage conversion circuit, which makes it possible to suppress variations in output voltage as compared to conventional technologies.

### Second Embodiment

Next, a second embodiment will be described. Note that in the description of the second embodiment the same configurations or configurations of the same quality as those in the above-mentioned description will be denoted by the same reference symbols, and overlapping description will be appropriately omitted. Further, unless otherwise stated, the matters described in the first embodiment can be applied to the second embodiment.

The circuit configuration of the power supply circuit in the second embodiment is the same as that of the first embodiment. In the second embodiment, the switching operation of the voltage conversion circuit 11 is performed in a burst mode (intermittent switching operation).

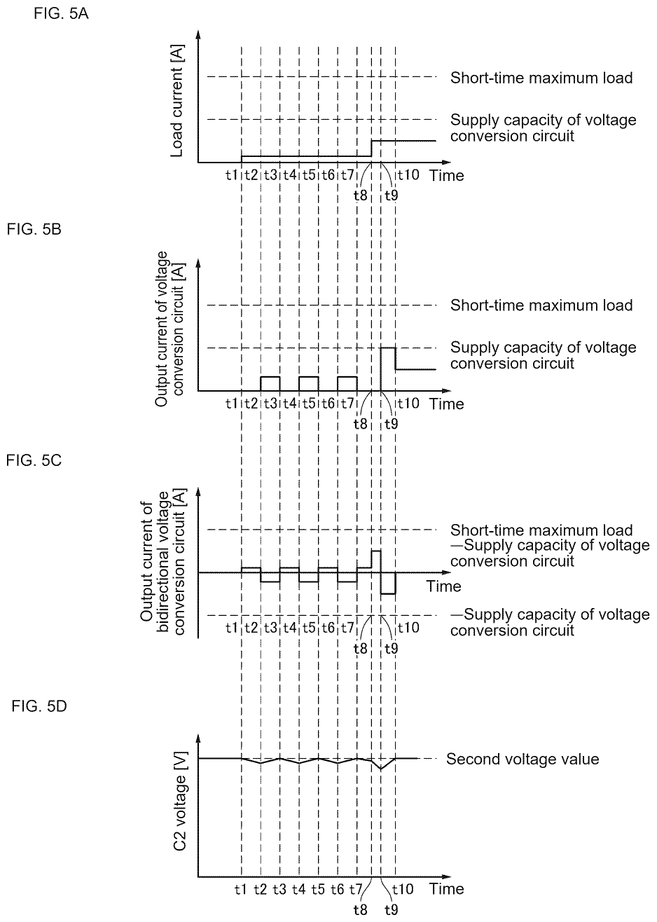

An operation example of the power supply circuit according to the second embodiment will be described with reference to FIG. 5. The contents shown in A to D of FIG. 5 are the same as the contents shown in A to D of FIG. 4.

As shown in A of FIG. 5, a load with a small load current from timing t1 to timing t8 is assumed. The load current is assumed to increase at timing t8. The voltage conversion circuit 11 performs an intermittent operation between timing t1 and timing t8 (light load region). As shown in B of FIG. 5, the voltage conversion circuit 11 outputs a current exceeding the load current, for example, from timing t2 to timing t3, from timing t4 to timing t5, and from timing t6 to timing t7. The current exceeding the load current flowing during those periods are charged in the second capacitor C2. In other words, the current exceeding the load current is output as a negative current from the bidirectional voltage conversion circuit 12 (see C of FIG. 5), and the second capacitor C2 is charged (see D of FIG. 5).

Further, in the period in which the voltage conversion circuit 11 is stopped, such as the period from timing t3 to timing t4 or from timing t5 to timing t6, the bidirectional voltage conversion circuit 12 supplies the current to the load (see C of FIG. 5). Thus, the voltage of the first capacitor C1 is kept constant.

When the load current abruptly increases at timing t8, that is, at the timing at which the voltage conversion circuit 11 is stopped, a response delay of the voltage conversion circuit 11 occurs, and the supply current of the voltage conversion circuit 11 is lacking for the load, but this lacking portion is supplied by the bidirectional voltage conversion circuit 12 (see C of FIG. 5). The bidirectional voltage conversion circuit 12 continues to keep the voltage of the first capacitor C1 constant by those operations, so that the conventional pulsation or the response delay of the load can be supplemented.

In general, there is known the technology of improving the power supply efficiency of the load in the light load range by causing the voltage conversion circuit to perform an intermittent operation. However, due to the problems such as the pulsation of the output voltage or the response delay of the load during the intermittence, the intermittent operation cannot be performed when the requested accuracy of the output voltage is high. However, as described above, according to this embodiment, the current requested by the load can be supplemented by the supply current from the bidirectional voltage conversion circuit 12 even if the response delay is caused, so that the occurrence of the above-mentioned inconvenience can be avoided.

### EXAMPLES

Next, the present disclosure will be described in detail using examples. Note that the present disclosure is not limited to the following examples.

### First Example

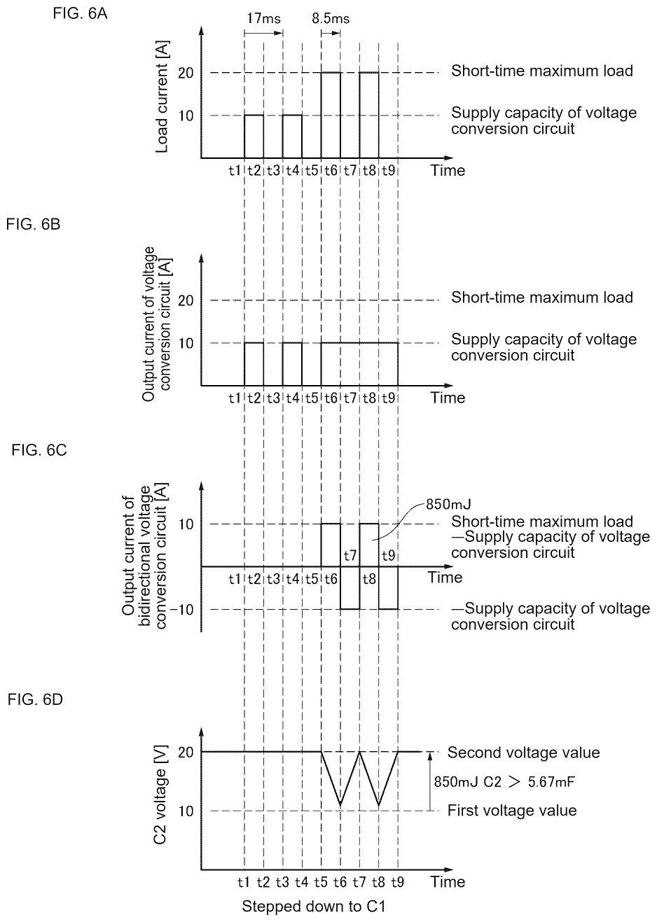

A to D of FIG. 6 show an example in which a step-down converter that steps down the voltage from the second capacitor C2 to the first capacitor C1 is applied as the bidirectional voltage conversion circuit 12. The contents shown in A to D of FIG. 6 are the same as the contents shown in A to D of FIG. 4.

In the case of using a step-down converter, a second voltage value that is set for the voltage conversion circuit 11 is set to a value larger than a first voltage value. Specifically, the first voltage value is assumed to be 10 V, and the second voltage value is assumed to be 20 V.

As shown in A of FIG. 6, assuming that the load operates at Duty 50% in the period of 17 ms and that the peak power is 200 W of 10 V·20 A, the average power is changed from Duty 50% to 100 W, and the voltage conversion circuit 11 needs to be capable of continuously supplying 100 W.

In the load range up to 100 W that can be supplied by the voltage conversion circuit 11 (e.g., the range from timing t1 to timing t2), the bidirectional voltage conversion circuit 12 continues an 0 A operation (see C of FIG. 6). At the peak load of 200 W, 100 W (current of 10 A) is supplied from the voltage conversion circuit 11, and 100 W is lacking for the load (load current of 20 A). The lacking power of 100 W is supplied from the bidirectional voltage conversion circuit 12 (see C of FIG. 6). Thus, the supply of the power to the load is continued. At that time, the energy stored in the second capacitor C2 is consumed, and the value thereof is 850 mJ in this example. To cover the energy of 850 mJ, the capacitance of the second capacitor C2 needs 5.67 mF or more.

The capacitance of the second capacitor C2 can be calculated as follows, for example.
The energy is calculated by

$$Lacking power P \times Lacking time t = Energy E .$$

The energy E in this example is

$$E = 100 [ W ] \times 8.5 [ ms ] = 850 [ mJ ] .$$

The energy that can be stored in the capacitor is represented by the following equation (1).

$$E = C * {V}^{2} / 2 \qquad ( 1 )$$

From the equation (1), in the example shown in FIG. 6,
C2>2E/(Vc2²−Vc1²) (where Vc2 represents the second voltage value, and Vc1 represents the first voltage value)
is established, and
the requested capacitance C2 in the second capacitor C2 is

$$C 2 = 2 * 850 [ mJ ] / ( {20 [ V ]}^{2} - {10 [ V ]}^{2} ) = 5.66 \cdot \cdot [ mF ] .$$

### Second Example

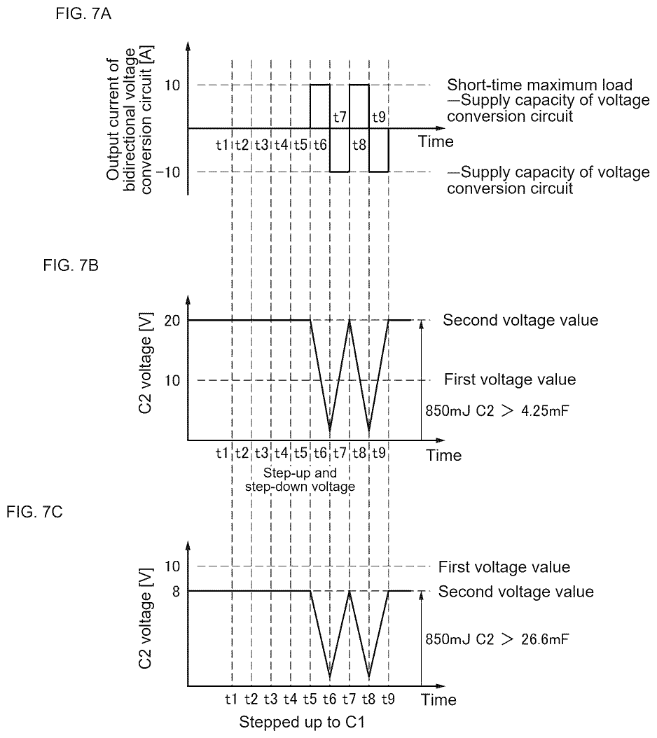

FIG. 7 is an example when a step-up and step-down or step-up bidirectional voltage conversion circuit 12 is used in the case of a load voltage and a load current similar to those of FIG. 6. A of FIG. 7 shows an output current of the bidirectional voltage conversion circuit 12. B of FIG. 7 shows a temporal change of the voltage of the second capacitor C2 when the bidirectional voltage conversion circuit 12 is a step-up and step-down converter. C of FIG. 7 shows a temporal change of the voltage of the second capacitor C2 when the bidirectional voltage conversion circuit 12 is a step-up converter.

In this example, since the bidirectional voltage conversion circuit 12 has a step-up function, there are no restrictions regarding a magnitude relationship between the first voltage value and the second voltage value, and the energy stored in the second capacitor C2 can be used up to the voltage of the first capacitor C1 or lower.

In this example, if the bidirectional voltage conversion circuit 12 is a step-up and step-down converter, capacitance of 4.25 mF or more is required as the capacitance of the second capacitor C2. If the bidirectional voltage conversion circuit 12 is a step-up converter, the second voltage value is set to be lower than the first voltage value. Assuming that the second voltage value is 8 V, the capacitance of the second capacitor C2 needs to be 26.6 mF or more.

As a specific calculation example, in the example shown in B of FIG. 7,

$$C 2 > 2 E / ( Vc {2}^{2} ) = 2 * 850 [ mJ ] / ( {20 [ V ]}^{2} ) = 4.25 [ mF ]$$

is established. In the example shown in C of FIG. 7,

$$C 2 > 2 E / ( Vc {2}^{2} ) = 2 * 850 [ mJ ] / ( {8 [ V ]}^{2} ) = 26.5625 [ mF ]$$

is established.

### <Modified Example>

The embodiments of the present disclosure have been specifically described above, and the contents of the present disclosure are not limited to the embodiments described above and can be variously modified on the basis of the technical ideas of the present disclosure.

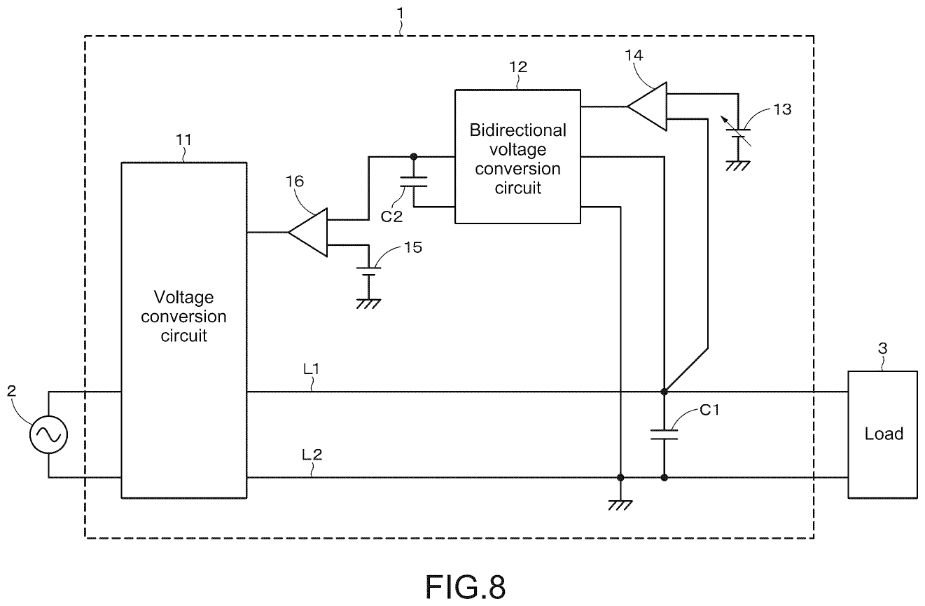

As shown in FIG. 8, the first voltage value set for the first reference voltage supply 13 may be not a fixed value but a variable value that can be set to any value. Further, the second voltage value set for the second reference voltage supply 15 may be a variable value. This makes it possible to optimize the first voltage value or the second voltage value in accordance with the load characteristics of various electronic apparatuses. Further, the first voltage value or the second voltage value may be dynamically changed in accordance with the load characteristics during the operation of the power supply circuit. This makes it possible to further improve the conversion efficiency of the power supply circuit. Further, setting the first voltage value to be variable makes it possible to cope with the control requested by an electronic apparatus serving as a load (e.g., desired to turn up/down volume, to increase/decrease luminance, and to increase/decrease the rotation speed of the motor).

The present disclosure can be implemented as not only a power supply circuit but also a control method performed by the power supply circuit or an electronic apparatus to which the power supply circuit is applied.

The configurations, methods, steps, shapes, materials, numerical values, and the like described in the embodiments described above are merely examples, and configurations, methods, steps, shapes, materials, numerical values, and the like different from those above can be used as necessary. The embodiments and modified example described above can be appropriately combined.

The present disclosure can also have the following configurations.

(1) A power supply circuit, including:
a voltage conversion circuit that converts an input voltage;
a first power storage element that smooths an output of the voltage conversion circuit;
a bidirectional voltage conversion circuit that is connected in parallel, on an output side thereof, to the first power storage element; and
a second power storage element that is connected to an input side of the bidirectional voltage conversion, in which
the voltage conversion circuit controls a voltage of the second power storage element to have a second voltage value, and
the bidirectional voltage conversion circuit controls a voltage of the first power storage element to have a first voltage value.
   (2) The power supply circuit according to (1), in which
when a load current of a load connected to the first power storage element is larger than a maximum suppliable current of the voltage conversion circuit, the voltage conversion circuit continues to output the maximum suppliable current.
   (3) The power supply circuit according to (2), in which
the bidirectional voltage conversion circuit supplies a discharge current to the first power storage element, the discharge current being caused by discharging the second power storage element.
   (4) The power supply circuit according to (3), in which
when the load current of the load falls below the maximum suppliable current of the voltage conversion circuit, the voltage conversion circuit continues to output the maximum suppliable current until the voltage of the second power storage element reaches the second voltage value.
   (5) The power supply circuit according to any one of (1) to (4), in which
the first voltage value is variable.
   (6) The power supply circuit according to any one of (1) to (4), in which
the first voltage value is a predetermined fixed value.
   (7) The power supply circuit according to any one of (1) to (6), in which
the second voltage value is variable.
   (8) The power supply circuit according to any one of (1) to (6), in which
the second voltage value is a predetermined fixed value.
   (9) The power supply circuit according to any one of (1) to (8), in which
the voltage conversion circuit operates in an intermittent switching operation.
   (10) A control method, including:
converting an input voltage by a voltage conversion circuit;
smoothing an output of the voltage conversion circuit by a first power storage element;
controlling a voltage of the first power storage element to have a first voltage value by a bidirectional voltage conversion circuit that is connected in parallel, on an output side thereof, to the first power storage element and connected on an input side thereof to a second power storage element; and
controlling a voltage of the second power storage element to have a second voltage value by the voltage conversion circuit.
   (11) An electronic apparatus, including
the power supply circuit according to any one of (1) to (10).

### REFERENCE SIGNS LIST

1 power supply circuit
2 input power supply
3 load
11 voltage conversion circuit
12 bidirectional voltage conversion circuit
13 first reference voltage supply
14 first error amplifier
15 second reference voltage supply
16 second error amplifier
C1 first capacitor
C2 second capacitor
L1, L2 output line

1. A power supply circuit, comprising:
a voltage conversion circuit that converts an input voltage;
a first power storage element that smooths an output of the voltage conversion circuit;
a bidirectional voltage conversion circuit that is connected in parallel, on an output side thereof, to the first power storage element; and
a second power storage element that is connected to an input side of the bidirectional voltage conversion, wherein
the voltage conversion circuit controls a voltage of the second power storage element to have a second voltage value, and
the bidirectional voltage conversion circuit controls a voltage of the first power storage element to have a first voltage value.

2. The power supply circuit according to claim 1, wherein
when a load current of a load connected to the first power storage element is larger than a maximum suppliable current of the voltage conversion circuit, the voltage conversion circuit continues to output the maximum suppliable current.

3. The power supply circuit according to claim 2, wherein
the bidirectional voltage conversion circuit supplies a discharge current to the first power storage element, the discharge current being caused by discharging the second power storage element.

4. The power supply circuit according to claim 3, wherein
when the load current of the load falls below the maximum suppliable current of the voltage conversion circuit, the voltage conversion circuit continues to output the maximum suppliable current until the voltage of the second power storage element reaches the second voltage value.

5. The power supply circuit according to claim 1, wherein
the first voltage value is variable.

6. The power supply circuit according to claim 1, wherein
the first voltage value is a predetermined fixed value.

7. The power supply circuit according to claim 1, wherein
the second voltage value is variable.

8. The power supply circuit according to claim 1, wherein
the second voltage value is a predetermined fixed value.

9. The power supply circuit according to claim 1, wherein
the voltage conversion circuit operates in an intermittent switching operation.

10. A control method, comprising:
converting an input voltage by a voltage conversion circuit;
smoothing an output of the voltage conversion circuit by a first power storage element;
controlling a voltage of the first power storage element to have a first voltage value by a bidirectional voltage conversion circuit that is connected in parallel, on an output side thereof, to the first power storage element and connected on an input side thereof to a second power storage element; and
controlling a voltage of the second power storage element to have a second voltage value by the voltage conversion circuit.

11. An electronic apparatus, comprising
the power supply circuit according to claim 1.
